(19) United States
(12) Patent Application Publication
(10) Pub. No.: US 2011/0165943 A1
(43) Pub. Date: Jul. 7, 2011

(54) Flight and Motion Simulator Control Mechanism

(76) Inventor: Thomas Eugene O`Neill, Herndon, VA (US)

(21) Appl. No.: 12/980,663

(22) Filed: Dec. 29, 2010

Related U.S. Application Data
(60) Provisional application No. 61/335,413, filed on Jan. 7, 2010.

(51) Int. Cl. A63F 13/02

(52) U.S. Cl. 463/36

(57) ABSTRACT

A flight and motion simulator control mechanism that uses an existing computer and commercially available flight simulator software to physically simulate and control the motions of personal flight. The control mechanism translates the movements of a user suspended from the mechanism into pitch and yaw commands to the flight simulator environment. The computer generated flight simulation is projected onto a screen encompassing the user's field of vision providing the sensation of flying and controlling the flight through bodily movements. The operator is suspended from the suspension frame which is connected to the stationary base unit. Rather than controlling movement of the computer generated flight in a seated position by manipulating a hand-controlled joystick as if simulating an aircraft cockpit, the user controls movement by shifting his weight forward, backward, left and right thereby simulating personal flight.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Simulated vehicle motion platforms have been used for decades for training vehicle operators as well as in computer-based entertainment systems to add realism to computer generated visual systems. Most motion simulator systems replicate to some degree an aircraft cockpit in which the operator is seated with a control stick or some other input device providing motion instruction to the computer. Much emphasis has been placed upon the enhancement of these systems in the areas of realism and vehicle operation from this perspective of flying an aircraft of some sort.

### BRIEF SUMMARY OF THE INVENTION

The purpose of this invention is to provide a flight and motion simulation input system that represents personal flight as opposed to simulating aircraft flight. Many varieties of flight simulation have come on the market that does not revolve around the use of an aircraft in the traditional sense. Today, systems in which personal avatars fly through computer generated environments must be performed using control mechanisms designed, at best, for aircraft simulation. By suspending the operator from the control mechanism in a way in which the operator's own shifts in weight and body movements provide the motion instruction to the computer, the invention allows for the sensation of personal flight as opposed to aircraft powered flight.

### BRIEF DESCRIPTION OF THE SEVERAL VIEWS OF THE DRAWING

The following diagrams and prototype pictures illustrate the invention. The invention is comprised of four main components: The Viewing Area (FIG. 1—A), the Suspension Area (FIG. 1—B), the Base and Housing Area (FIG. 1—C), and the Sled (FIG. 1—D). Additionally, throughout the illustrations photographs of my original prototype are used to further detail the description.

FIG. 1 represents a side view of the invention in its entirety. Three areas of focus are identified (A, B, and C) and are detailed in following FIGS. 2, 3, 4, and 5.

FIG. 2 represents a detail set of views of the Viewing Area, including the mirrored surface and rear projection screen. Details of the individual components are provided in breakout illustrations.

FIG. 3 represents an angled overhead view and details of the Suspension Area, including the rolling bars and joystick mechanism. Details of the individual components are provided in breakout illustrations.

FIG. 4 represents a side view of the Base and Housing Area, including the base, support poles and projection house.

FIG. 5 represents an illustration of the riding sled used in the developed prototype as well as an optional chair configuration.

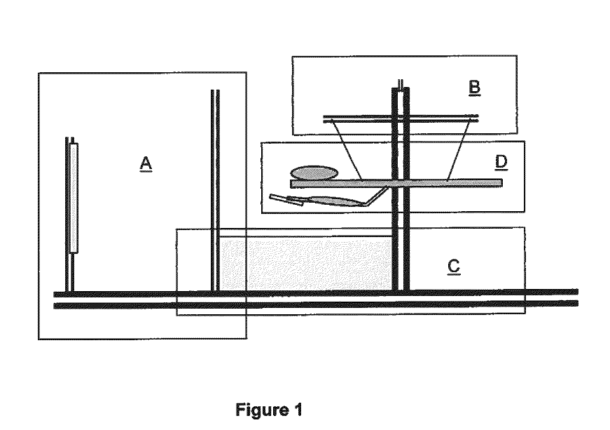

### DETAILED DESCRIPTION OF THE INVENTION

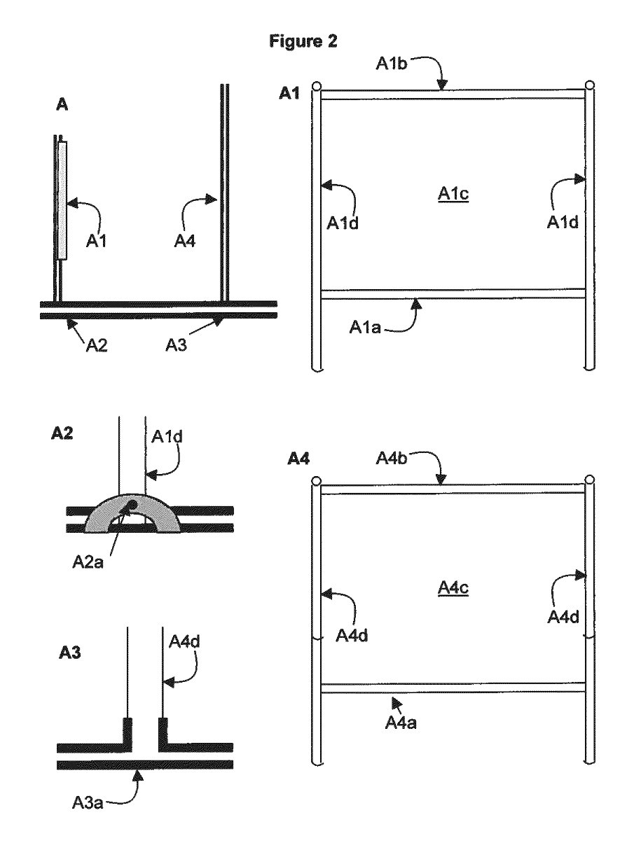

The Viewing Area (FIG. 2):_The image generated by the computer is rear projected on to a screen (FIG. 2—A4) that encompasses the flier's field of view. This may be projected directly or off of a mirrored surface (FIG. 2—A1) depending upon desired configuration.

Mirrored Surface: The mirrored surface (FIG. 2—A1c) is supported by rigid support bars (FIG. 2—A1b) connecting the surface area to the Base via an adjustable position lock (FIG. 2—A2a) that allows the entire mirror area to be raised or lowered based upon projection configuration requirements. The mirrored surface itself is held in place between the support bars by appropriate support structures (FIG. 2—A1a)

Rear Projection Screen: The projection screen (FIG. 2—A4c) is in front of the flier while he is attached to the suspension area and displays the simulated flight path projected by the computer. The screen is supported from the top by a static support bar (FIG. 2—A4b) and can be retracted into the bottom bar (FIG. 2—A4a) if needed. The support bars connecting the projection screen to the base (FIG. 2—A4d) are telescopic so they can be lowered as the projection screen is retracted. The support bars may be locked to the base (FIG. 2—A3a) or connected via an adjustable position lock (FIG. 2—A2a).

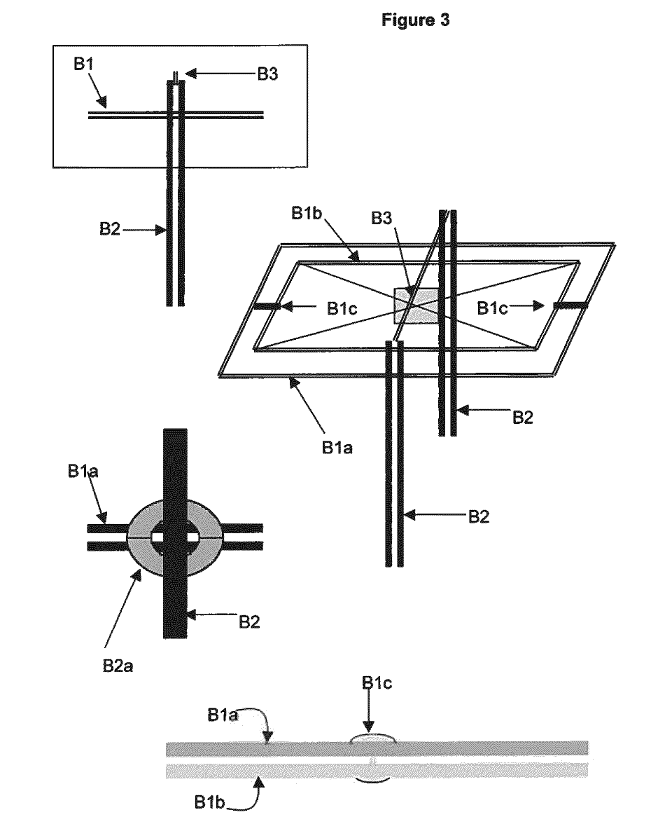

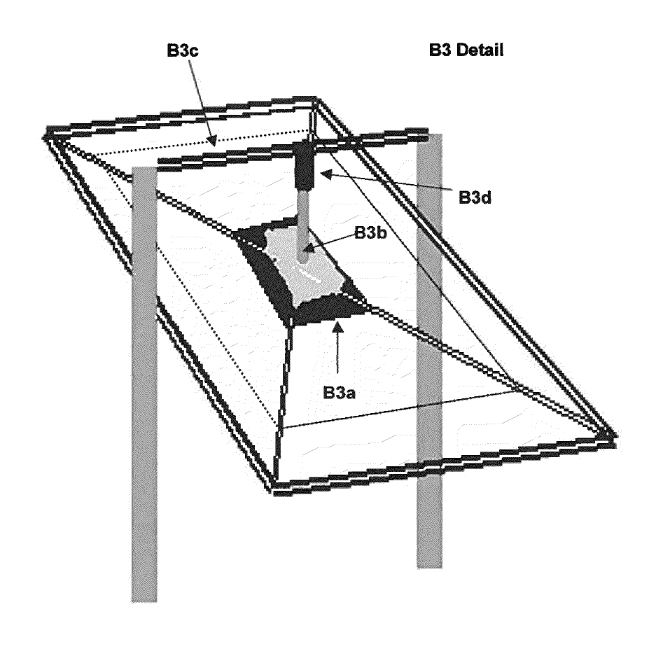

The Suspension Area (FIG. 3): The suspension area is made up of the series of interacting parts that fulfills two primary functions. First, it allows the flier to be suspended from above to provide the sensation of being airborne. Second, it converts the flier's three-dimensional movements into corresponding input to the computer running the flight simulation.

Rolling Bars: The outer (FIG. 3—B1a) and inner (FIG. 3—B1b) rolling bars are supported in a manner that allows for a potentially full range of motion along two rotational axis. The outer rolling bar is attached to the support pole (FIG. 3—B2) by a rotational connector (FIG. 3—B2a) that allows the bars to move 90 degrees either direction in relation to the support pole. This allows the flyer, by shifting weight forward, to rotate the pitch forward so that the face moves toward the floor. By shifting weight back, the flyer rotates the pitch backward, bringing the feet closer to the floor. This is translated through the joystick mechanism to the computer as “up” and “down” in the simulator. The inner and outer rolling bars are connected to each other by another rotational connector (FIG. 3—B1c) that allows the inner rolling bar to move 90 degrees to the left or right in relation to the outer rolling bar. Thus, by shifting weight, the flyer can control the yaw left or right and that movement is translated through the joystick mechanism to the computer as “left” and “right” in the simulator.

Joystick Mechanism: The joystick mechanism (FIG. 3—B3) translates the up, down, left, and right motion of the rider into the appropriate responses in the computerized flight simulation. While there are a number of ways in which this can be accomplished, this particular model uses a standard, generally available joystick (B3 Detail—B3b) situated in a way that its base is fastened securely to the center of the inner rolling bar (B3 Detail—B3a). Meanwhile, the top of the joystick (B3 Detail—B3d) is fastened is fastened to a stationary crossbar (B3 Detail—B3c) that is supported and attached to the support poles. By keeping the top of the joystick held stationary by the crossbar and allowing the base to rotate in conjunction with the movement of the inner and outer rolling bars, the movement of the flyer is translated into the equivalent movement of the joystick. The joystick should be positioned so that the projected movements correspond with the movements of the flyer. For example, the joystick may be reversed if the system is fitted with a mirror reflecting on to a rear-projection screen as in the case of the prototype illustrated.

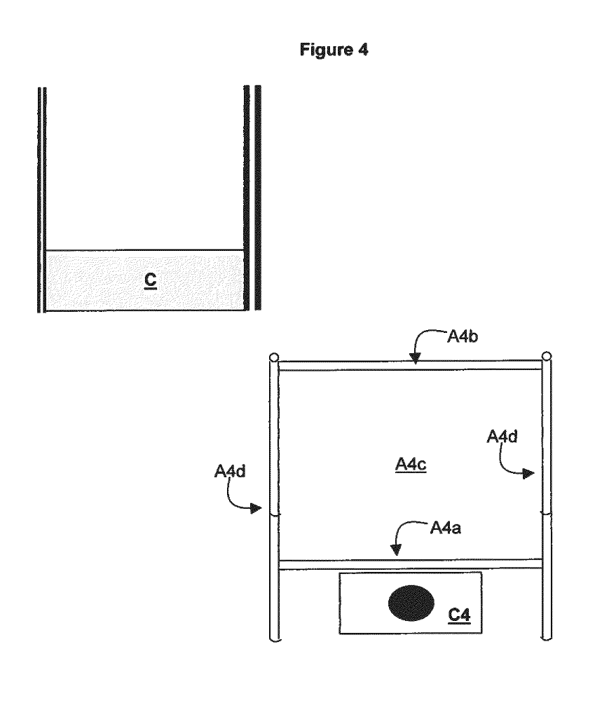

The Base and Projection House (FIG. 4) Base: The base supports the entire structure, specifically through the support poles (FIG. 3—B2), the mirrored surface support bar (FIG. 2—A1b) and the projection screen support bar (FIG. 2—A4d). It is possible to construct the base and support bars in a variety of ways that maximize flexibility, compactness, and sturdiness. Options that include telescopic supports that can be lowered into themselves or supports attached by adjustable locks that can be moved into different positions allow for making the system more compact when not in use.

Projection House: The most compact option of projecting the simulation onto the flyer's field of vision is by using a mirrored surface and rear-projection screen to create a wide projection area at minimal projection length. To accomplish this, the system houses the projector under the flyer (FIG. 4—C4). Ideally, the flyer is enclosed such that external fight does not interfere with the projected image.

Flyer Suspension: The flyer can be suspended from the inner rolling bar (FIG. 3—B1b) in any number of ways limited only by imagination. A sled mechanism might be used on which the flyer lays or sits on or the flyer might be attached to the inner rolling bar directly via a specially designed suit. The only requirement is that the attached mechanism must be weight balanced such that in neutral position the inner and outer rolling bars are even. In this way, there is no weight imbalance to interfere with the flyer's own shifts impacting the simulation.

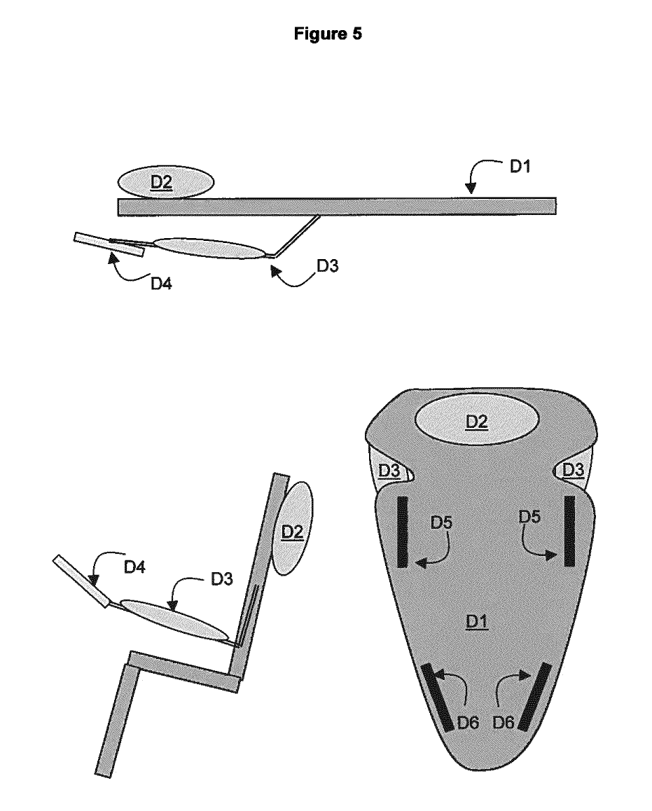

The Sled: In the prototype illustrated in this document, I have created a sled mechanism (FIG. 5—D) on which the rider lies face down with head pointing towards the screen. The sled is attached to the inner rolling bar by cable that is connected to the sled at front (FIG. 5—D5) and back (FIG. 5—D6) fasteners. The sled is balanced such that at neutral position, the rider is lying horizontally without tilt to the left or right. This translates into a neutral joystick position being fed into the computer. The sled allows the flyer to comfortably shift weight forward, backward, left and right while being in continuous visual contact with the screen. The flyer lies on the bed of the sled (FIG. 5—D1) with his head supported by the head cushion (FIG. 5—D2). The flyer's arms rest upon the arm supports (FIG. 5—D3), which allow the flyer to shift weight as described above. This configuration also allows for rider hand access to a control board area (FIG. 5—D4). This area can be used for the placement of other devices supporting the simulation experience. These devices may include, but are not limited to, computer keyboard, mouse, fan control, mist control, scent release, audio controllers, etc.

With slight modifications to the existing prototype, the sled could be configured to support the rider in a sitting position (FIG. 5—D chair configuration, side view). As in the horizontal position, the rider will be able to change the position of the sled through shifting his weight.

Additional Uses and Modifications: With simple modifications, this invention can be used to simulate motion in a variety of manners. With changes to the sled, various bodily positions can be supported and utilize the same range of motion. Examples are given of potential sled configurations in the section above. Additional body positions supported by different sled configurations include: lying horizontally or at an incline, sitting vertically or at an incline, and standing. In addition to supporting different positions, the sled can be constructed to simulate objects upon which the individual would ride. For example, the sled might take the shape of a broom to coincide with games standing. In addition to supporting different positions, the sled can be constructed to simulate objects upon which the individual would ride. For example, the sled might take the shape of a broom to coincide with games simulating broomstick flight. In addition, sleds could be constructed in which the individual is supported from behind as in a jetpack in which the flyer is supported below the jetpack sled. In each case, the means of movement and control remain the same and modification to the rest of the invention is minimal if any.

Environmental Simulation: Additional improvements can be built into the invention or attached to it in order to heighten the simulation experience even further. Fans can be strategically placed to provide air current to further the sensation of movement. Likewise, any number of apparatus can be used on a timer or in correlation with the software simulation, such as scent dispensers and mist dispensers, to give the sense of flying through clouds, passing through evergreen forests, etc.

Storage and Configuration Options: The prototype demonstrated in this document makes use of telescopic poles and adjustable lock positions in order to make the invention compact and easier to store when not in use. Different approaches can be used to achieve the same effect without compromising the general structure and functionality.

What is claimed is:

1. A flight and motion simulator input device for use with an existing computer and commercially available software comprising:
A) a base frame providing support bars for the viewing area and suspension area
B) a viewing area that includes
i. a mirrored surface
ii. a rear projection screen encompassing the user's field of vision attached to the base frame
C) an outer rolling bar connected by a rotational connector to the base support bar allowing the outer rolling bar to rotate 90 degrees from horizontal in either direction in relation to the support pole
D) an inner rolling bar connected by a rotational connector to the outer rolling bar allowing the inner rolling bar to rotate 90 degrees from horizontal in either direction in relation to the outer rolling bar
E) a joystick mechanism attached to the inner rolling bar by the joystick mechanism's base and which the joystick mechanism's control stick is held stationary
F) a suspension mechanism connecting the user to the inner rolling bar above the user

2. A flight and motion simulator input device according to claim 1 in which the movements of a suspended user are translated into directional commands to the simulator environment

3. A flight and motion simulator input device according to claim 1 that translates the weight shifts of a user suspended from the inner rolling bar into pitch movements by the outer rolling bar and yaw movements by the inner rolling bar that are input through the joystick mechanism into directional commands to the simulator environment.
